(19) United States
(12) Patent Application Publication
(10) Pub. No.: US 2011/0070560 A1
(43) Pub. Date: Mar. 24, 2011

(54) TOOTH-WHITENING METHOD

(76) Inventor: Paul HERTZ, Bronx, NY (US)

(21) Appl. No.: 12/885,692

(22) Filed: Sep. 20, 2010

Related U.S. Application Data
(60) Provisional application No. 61/245,015, filed on Sep. 23, 2009.

(51) Int. Cl. A61C 19/06

(52) U.S. Cl. 433/215

(57) ABSTRACT

A method of whitening teeth has the steps of applying chlorine dioxide to surfaces of the teeth, leaving the solution on the teeth for a predetermined time, rinsing the solution from the teeth, repeating previous two steps at least once, and applying tubule sealant to the surfaces.

### FIELD OF THE INVENTION

The present invention relates to tooth-whitening method.

### BACKGROUND OF THE INVENTION

Tooth whitening is typically a fairly lengthy and uncomfortable process. Once the preliminary work—reviewing the patients medical history, doing a dental exam, and, if necessary, a periodontal cleaning—the procedure can take two hours of chair time—one hour work, one hour prep and breakdown—partly because it is necessary to mask the patient's gums from the fairly aggressive chemicals used. In addition existing chair-side bleaching techniques use and require a high intensity light as an energy source to accelerate the chemical reaction that leads to tooth whitening

### OBJECTS OF THE INVENTION

It is therefore an object of the present invention to provide an improved tooth-whitening method.

Another object is the provision of such an improved tooth-whitening method that overcomes the above-given disadvantages, in particular that is particularly fast, that produces results at least as good as those of the longer prior-art procedures, and that is more comfortable for the patient during the process and has no or little postoperative sensitivity, as occurs in the prior-art process.

### SUMMARY OF THE INVENTION

A method of whitening teeth has according to the invention the steps of applying chlorine dioxide to surfaces of the teeth, leaving the solution on the teeth for a predetermined time, rinsing the solution from the teeth, repeating previous two steps at least once, and applying tubule sealant to the surfaces.

### SPECIFIC DESCRIPTION

The typical whitening according to the invention comprises the following steps:

### Step 1

Review Medical History

Brightening is not to be done on anyone with uncontrolled disease process, open oral ulcers, diseased or traumatically broken vital teeth, so a dental exam must be done.

A periodontal cleaning must have been completed within the last 2 months to insure periodontal health.

### Step 2

Pre-operative shade matching confirmed with the patient/optional photo confirmation with the patient

### Step 3

Activate brightening solution by dispensing dual syringe plunge and dispensing activated solution into bottom ⅓ of a 3 cc luer-lock syringe.

### Step 4

Very quick prophylaxis of anterior and pre molar teeth including light scaling to remove superficial calculus

### Step 5

Application of vitamin E/Petroleum jelly to gums followed by placement of cheek retraction.

One cotton roll may be placed centrally under upper lip and one under bottom lip to better isolate teeth.

Keep Petroleum jelly off teeth

### Step 6

Place plunger in 3 cc syringe to expel air, leaving approximately 2 cc of material.

Twist on luer lock needle tip of desired lumen.

Expel both buccal and lingual activated solution onto the incisal halves of teeth 4-13 & 20-29.

Using disposable brush spread solution on teeth to cover entire teeth with about 1 cc of solution for a coating thickness of about 2 mm.

Agitate solution with disposable brush for 2 minutes.

### Step 7

Using an ultrasonic handpiece and activating attachment or halogen or LED curing light. Thus mechanical energy or light is applied to the brightening solution on the teeth for one minute.

Solution will turn from yellow to white.

### Step 8

Suction off gross excess of spent solution and have patient rinse.

### Step 9

Repeat Steps (7-10) three to five more times as necessary.

Applying petroleum jelly to gingiva periodically.

### Step 10

Dispense mineralization paste into dampen dish (approximately 1.5 cc) Brush onto teeth with prophylaxis brush.

Allow to sit 4 minutes.

### Step 11

Patient rinses.

Final shade is taken.

Patient given paste to use for 2 weeks 2× daily.

### Step 12

Apply tubule sealant with disposable brush—wait one minute.

Patient is released

### Technique Two

### Step 1

Custom tray fabricated.

### Step 2

Petroleum jelly/vitamin E applied to anterior gingival.

### Step 3

Light prophylaxis anterior teeth.

### Step 4

Place brightening solution activated, dispersed into custom tray, wait 2 minutes.

### Step 5

Set tray in mouth for 5 minutes—apply ultrasonic mechanical energy or use halogen curing light for 1 minute. The ultrasonic energy is applied with the below-described fork headpiece attchment.

### Step 6

Repeat 3 times/rinse tray between applications. Patient rinses mouth between applications.

### Step 7

Rinse tray and apply activated mineralization paste and set for 5 minutes.

### Step 8

Apply tubule sealant with disposable brush—wait one minute.

### Step 9

Release patient.

The bleaching substance used is chlorine dioxide (ClO₂) produced by acidifying a solution of sodium chlorite (NaClO₂). Chlorine dioxide has the considerable advantage that it does not damage the lactobacteria of intestinal flora, and when left in water or food leaves nothing behind but harmless sodium chloride (NaCl) A concentration of 4 ppm is used for teeth according to the invention.

According to the instant invention the process can be assisted by fitting to a beaver tip of an ultrasonic (25,000 30,000 oscillations/sec) scaler a solid fork-shaped appliance or attachment that is held against the teeth. The fork-shaped appliance transmits mechanical energy to the teeth but does not become uncomfortably hot when held in one location

I claim:

1. A method of whitening teeth comprising the steps of:
a) applying chlorine dioxide to surfaces of the teeth;
b) leaving the solution on the teeth for a predetermined time;
c) rinsing the solution from the teeth;
d) repeating steps a) and b) at least once; and
e) applying tubule sealant to the surfaces.

2. The method defined in claim 1 wherein the predetermined time is between 2 and 6 minutes.

3. The method defined in claim 1 wherein the predetermined time is 4 minutes.

4. The method defined in claim 1 wherein the chlorine dioxide is applied to the teeth with a syringe.

5. The method defined in claim 4 wherein after the chlorine dioxide is applied with a syringe, it is distributed over the tooth surfaces with brush.

6. The method defined in claim 1 further comprising after step d):
d′) activating the solution by ultrasonically stimulating the teeth.
